(19) United States
(12) Patent Application Publication
(10) Pub. No.: US 2021/0129379 A1
(43) Pub. Date: May 6, 2021

(54) EXTRUDER

(71) Applicant: Michael Sherrill, Bat Cave, NC (US)

(72) Inventor: Michael Sherrill, Bat Cave, NC (US)

(21) Appl. No.: 17/086,167

(22) Filed: Oct. 30, 2020

Related U.S. Application Data
(60) Provisional application No. 62/928,330, filed on Oct. 30, 2019.

(51) Int. Cl. B28B 3/26; B28B 3/24

(52) U.S. Cl. CPC B28B 3/26; B28B 3/24

(57) ABSTRACT

The instant invention describes an extruder for shaping clay or similarly pliable materials into desired shapes. The extruder comprises an operational section, a cassette, and a die. The operational section comprises a plunger, a means for controlling movement of the plunger, a means for supplying electricity, and a body to provide an exterior housing. The cassette, which is removably attached to the operational section, comprises a cavity for holding extrusion material through which the plunger will pass. The die comprises an aperture used to shape the extrusion material and is able to he attached to the cassette.

### FIELD OF THE INVENTION

The present invention relates to an extruder for the formation of clay or similarly pliable materials in particular shapes.

### BACKGROUND OF THE INVENTION

Clay extruders are often used by potters and sculptors for shaping clay into uniform shapes. Many extruders are designed to accept interchangeable dies to allow for various shapes to be formed. The formed shapes may be solid or hollow depending on the particular die used.

Existing clay extruders can be categorized into four classes: clay extruder guns, mechanical large format clay extruders, pneumatic powered large format clay extruders. And hydraulic extruders. Clay extruder guns may be small enough to be held in the palm of a hand and able to be paired with dies of less than one inch in diameter or may be larger, up to about 2 inches in diameter. For larger diameters, artists must look to large format clay extruders. Typical mechanical large format clay extruders are attached to a wall and are operated by pulling down a lever to cause a plunger to push clay through a die. The act of pulling the lever requires a not insignificant amount of force to operate the lever, and many artists are unable to easily and comfortably operate such extruders. Moreover, because of the force required to operate them, it is sometimes difficult for users to tightly control the amount of clay that is shaped, causing users to waste time in managing the excess extruded clay. Large format extruders operated through connecting to air compressors or a hydraulic pump work in much the same way, though the air compressors and pumps provide the force necessary to operate the levers and offer the option to more easily control the amount of clay extruded. Air compressors and hydraulic machinery are, of course, not inexpensive and quite noisy, and they are not suitable for some work environments.

Accordingly, there exists a need for extruders that may be used to produce larger extruded forms without either the force necessary to operate a mechanically operated lever or the noise and expense of utilizing an air compressor or hydraulics to operate the extruder.

### SUMMARY OF THE INVENTION

As described herein, the invention consists of an extruder for shaping clay or similarly pliable material into desired extruded shapes. The inventive extruder first comprises an operational section. This operational section comprises the body of the extruder, which serves as an outer housing. The operational section further comprises, within the body, a plunger for pushing extrusion material through the cassette, a means for controlling movement of the plunger, and a means for supplying electricity to control the operation of the plunger. The body also includes a means for attaching to the body a cassette for holding extrusion material to he extruded. The extruder further comprises the cassette, which is a cavity for holding extrusion material that will be shaped through which the plunger will pass. The cassette is removably connected to the body of the extruder. The die comprises an aperture used to shape the extrusion material and is able to be attached to the cassette.

### BRIEF DESCRIPTION OF THE DRAWINGS

The accompanying drawings, which are incorporated in and constitute part of the specification, illustrate embodiments of the invention and, together with the description, serve to explain the principles of the invention.

FIG. 1 is a perspective view of an extruder in accordance with the present design.

FIG. 2 is a perspective view of the extruder with the cassette removed from the body.

FIG. 3 is an exploded view of the cassette of the extruder.

FIG. 4 is a front view of the extruder reflecting the cut line fix the interior section views in FIGS. 5-8.

FIG. 5 is an interior section view of the extruder with a plunger not having been actuated.

FIG. 6 is a detail view of a portion of the the interior section view of the extruder.

FIG. 7 is the interior section view of the extruder with the plunger having been fully actuated.

FIG. 8 is an interior section view of the extruder depicting the electrical components.

FIG. 9 is a top view of a first die, a second die, and a zipper bridge connector.

### DETAILED DESCRIPTION OF THE DRAWINGS

Embodiments of the present invention will be described with reference to the drawings. The invention is not intended to be limited to the embodiment as depicted and described herein and can be altered, modified, improved without departing from the scope of the present invention.

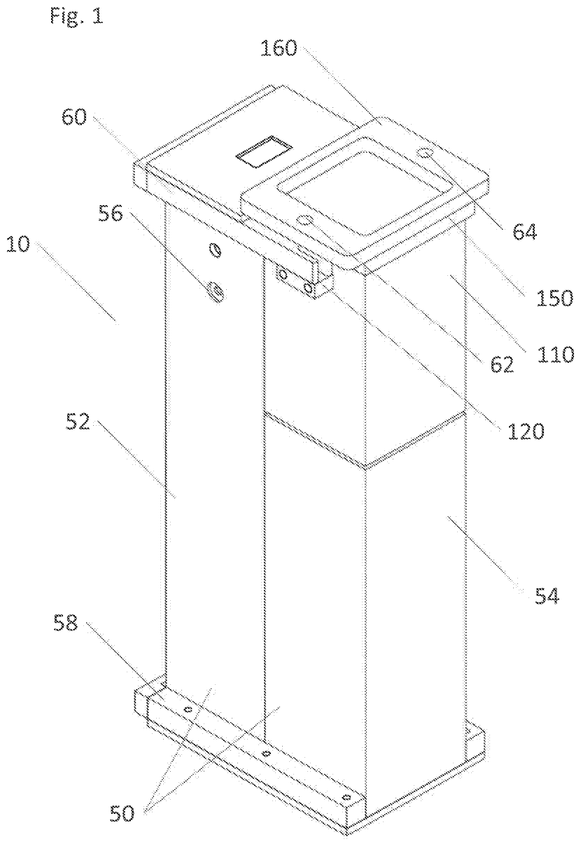

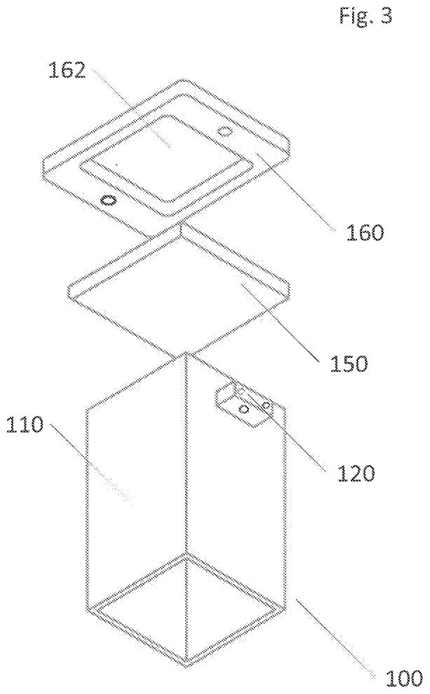

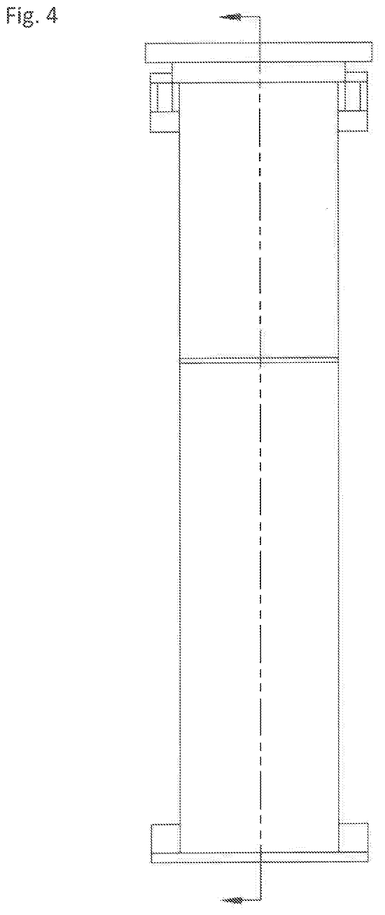

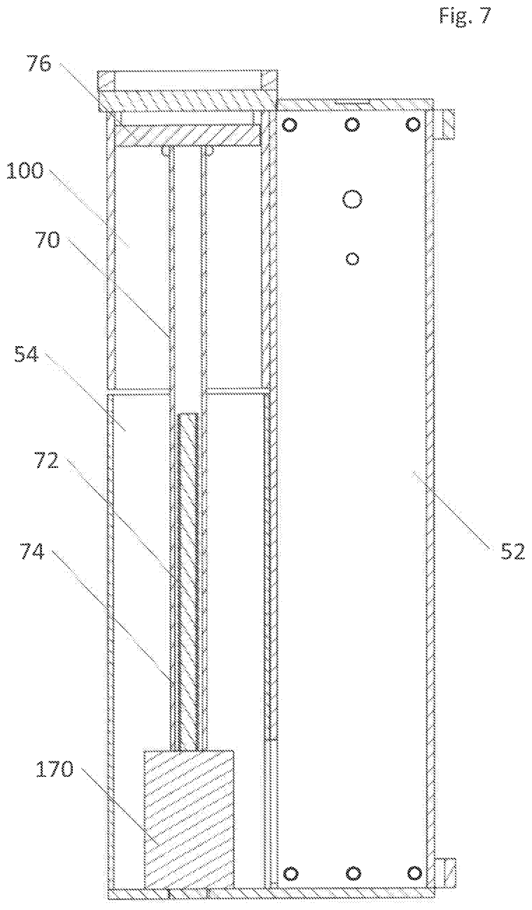

FIGS. 1-9 depict at least one embodiment of an extruder 10 of the present invention. The extruder 10 includes an operational section body 50, a cassette 100, and a die 150. The operational section body 50 comprises a back section 52, a front section 54, and a base 58 that holds the back section 52 and front section 54 together. The back section 52, front section 54, and base 58 may be manufactured as a single section or in more than three sections.

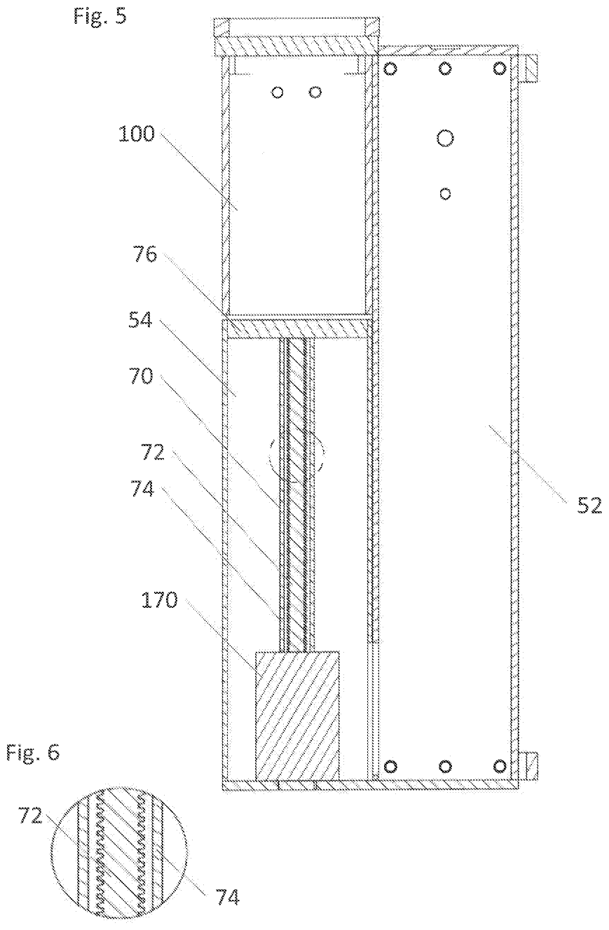

As shown in FIGS. 5-7, the front section 54 houses the entirety of a plunger 70 when it has not yet been actuated and an electrical supply means 170. The plunger 70 comprises a rod 74 and a head 76, which is attached to the distal end of the rod 74. The proximal end of the rod 74 is connected to and, when the plunger 70 is hot fully actuated, partially slotted into the electrical supply means 170. A threaded post 72 is also connected to and partially slotted into the electrical supply means 170. The hollow interior of the rod 74 is threaded for engagement with the threaded post 72. The action of the plunger 70 is controlled by the electrical supply means 170, which places a rotational force on the rod 74 such that the threads within the rod 74 rotates around the threaded post 72. When the rod 74 is turned in one direction, the plunger 70 will extend, moving toward and eventually into the cassette 100. When the rod 74 is turned in the opposite direction, the plunger 70 will retract, moving away from the distal end of the cassette 100. The manipulation of a plunger within other embodiments of the inventive extruder may operate in ways obvious to those skilled in the art. For example, the plunger may function in a telescoping manner. A telescoping plunger might have an inner rod fit within an outer rod with a head fit to the distal end of the inner rod, and a drive mechanism for controlling the plunger's movement would cause the inner rod to extend beyond the outer rod. Such a drive mechanism may include a leadscrew with a nut nesting within the inner rod and serving to control the inner rod's movement.

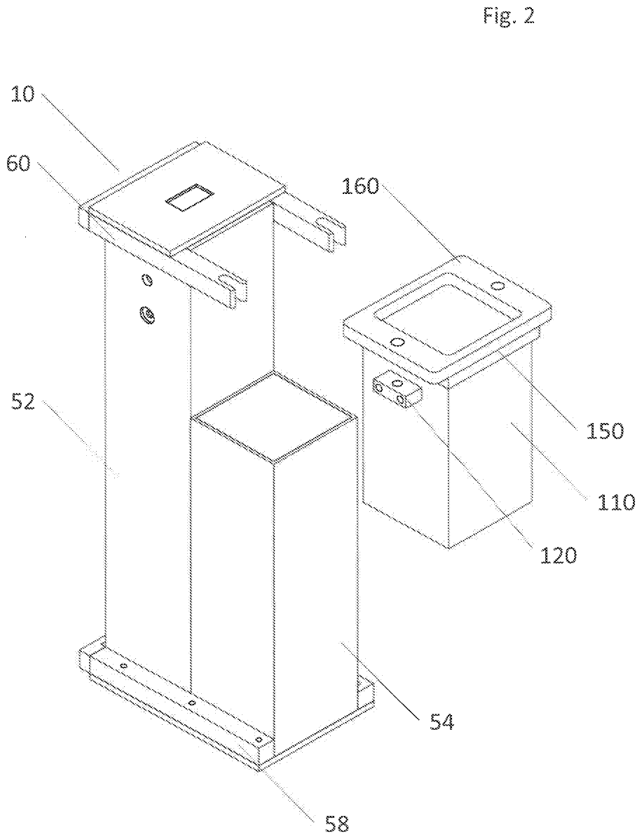

The operational section also includes a cassette connector 60 for attaching the cassette 100 to the body 50. The cassette connector 60 may be secured to the operational section body 50 in any number of ways, such as, for example, providing for a click fit, screw fit, pressure fit, or some combination thereof. In the depicted embodiment, the cassette connector 60 is removably secured to the cassette 100 by means of threaded bolts 62, 64, each of which passes through a die cleat 160, frictionally fits into a slot in the cassette connector 60, and is threaded into a bracket 120 secured to the side of the cassette body 110 as shown in FIGS. 1-2. The threaded bolts 62, 64 thus provide for alignment of the cassette 100 with the body 50 as well as securely attaching the cassette 100 to the body 50.

The cassette 100 is designed to hold a supply of extrusion material to be extruded. As may he seen in FIGS. 1-3, the cassette 100 comprises a cassette body 110. At the distal end of the cassette body 110 shall be a means for shaping extrusion material. As shown in the depicted embodiment, such means consists of a die 150, which fits to the distal end of the cassette body 100. The die 150 shall have an aperture (not shown), which dictates the shape of the extrusion material. The cassette 100 further comprises a die cleat 160, Which is a plate of rigid material with an aperture 162, and pair of brackets 120 (second bracket not shown), which, as described above, removably secure the cassette 100 to the body 50 of the extruder 10.

While the cassette body 110 may be shaped in any number of ways, the interior of the cassette body 110 shall have a shape and diameter just large enough within which the head 76 of the plunger 70 may fit. As described above, the plunger 70 in its unactuated position is housed within the body 50. The electrical supply means 170 may cause the plunger 70 to extend from the body 50 into the cassette 100. As the head 76 of the plunger 70 meets with the extrusion material held within the cassette 100, the extrusion material is pushed to the distal end of the cassette 100, through the die 150 and an aperture 162 in the die cleat 160, and to the exterior of the extruder 10. Since the cassette 100 is removably attached to the body 50 of the extruder 10, the cassette 100 can be removed for reloading with additional extrusion material or for cleaning following completion of use.

The extruder 10 may further incorporate an indicator (not shown) to provide the user with information regarding the location of the head 76 of the plunger 70. The indicator may be a light or set of lights. In one embodiment, the indicator may be a single light that displays one color, for example green, when the plunger 70 is fully retracted and a second color, for example red, when the plunger 70 is fully extended. In another embodiment, the indicator may be a single light that displays one color when the plunger 70 is fully retracted, a second color when the plunger 70 is fully extended, and a third color when the plunger 70 is somewhere between fully retracted and fully extended. In other embodiments, there may be two lights, one to indicate when the plunger 70 is fully extended and the second to indicate when the plunger 70 is fully retracted. In still further embodiments, there may be a plurality of lights with one light indicating when the plunger 70 is fully extended, a second light indicating when the plunger 70 is fully retracted, and one or more lights indicating that the plunger is somewhere between hilly retracted and fully extended.

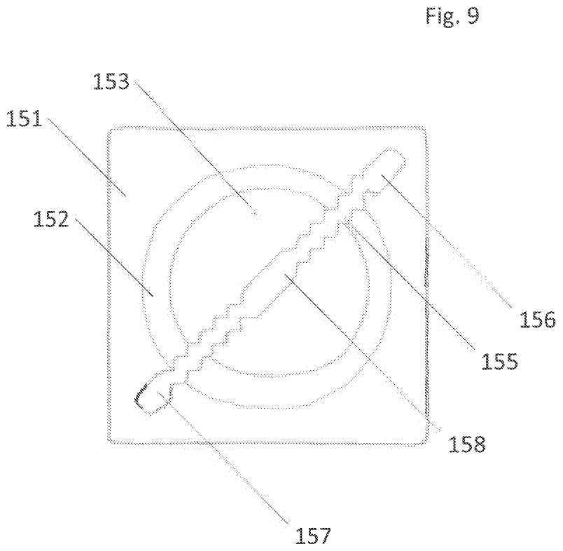

Optionally, the extruder 10 may incorporate a means to attach a second die 153 to allow for extrusion of hollow shapes. This may be accomplished in a number of ways such as, for example, the embodiment shown in FIG. 9. Here, a first die 151 would be sized such that it could be coupled to the cassette body 110 through use of the die cleat 160. The second die 153 would be a solid shape that would fit within the aperture of the first die 151, leaving a void 152 between the two. A bridge, here a zipper bridge 155, would connect the first die 151 and second die 153 at three points: a first connection point 156 and a second connection point 157 at either end of the zipper bridge 155 would be connected to the first die 151 and a third connection point 158 would be located on the second die 153. While a bridge may be formed in a variety of shapes, the zigzag shape between the connection points 156, 157, 158 of the zipper bridge 155 is preferable in that it allows the extrusion material to knit itself back together after having passed through the void 152 between the first and second dies 151, 153. When the extrusion material is clay, this easy rejoining of the material allows for immediate manipulation of the extrusion material after it has been extruded and further decreases seam failure and cracking during drying and firing.

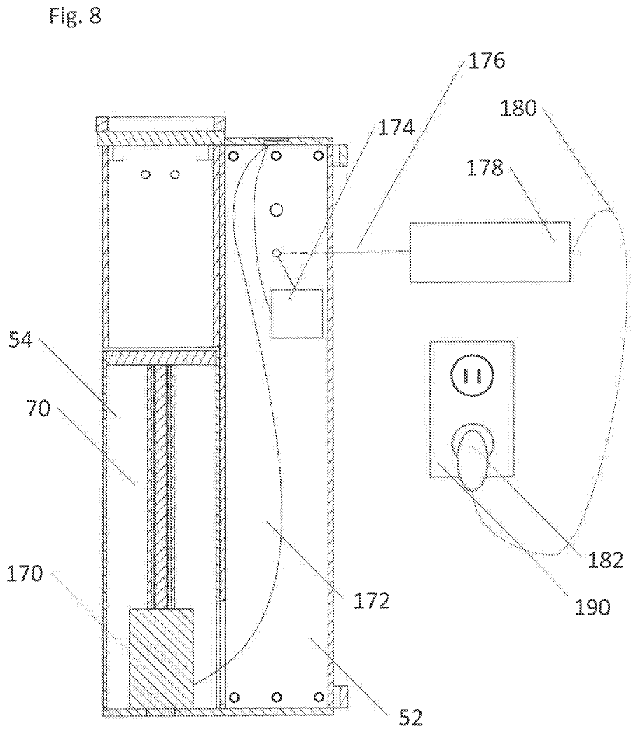

As can be seen in FIG. 8, the front section 52 houses the electrical supply means 170. The electrical supply means is connected to the DC power supply 174 located within the back section 52 of the extruder 10 by a first DC electrical supply cord 172. As shown in this particular embodiment, a second DC electrical supply cord 176 passes through the back section 52 and to the exterior of the extruder, connecting the DC power supply 174 to an AC adapter 178. The AC, adapter 178 connects to a standard electrical socket 190 through an AC outlet cord 180 ending in an AC plug 182. The supplied electricity provides the means necessary to control the operation of the plunger 70 as described above, in certain embodiments, the body 50 will comprise a controller 56 for turning the electricity on and off and controlling the speed at which the plunger 70 operates. Using low voltage electricity within and close to the extruder 10 is especially beneficial since low voltage is safer. The reduced shock risk is of particular importance when working with certain types of extrusion materials, such as clay, since the environment may be wet for ease of manipulating the material.

Due to the incorporation of an electric power supply and a securely seated cassette 100, the extruder 10 taught herein is capable of operation vertically and extruding downward as is traditionally seen but also will function in all manner of other orientations as well. The force provided by the electric power supply and the ability to control the speed of extrusion allows for extrusion in vertically upward direction, a horizontal direction with the extruder 10 positioned on its side, or in any manner of diagonal orientation as well,

Those skilled in the art will recognize that modification and adaptions to the invention are possible without departing from the intended scope of the invention. Many variations and modifications may be achieved within the spirit and scope of the invention as described in the appended claims. The components parts and steps of use described herein need not be perforated in the order described, and component parts and steps may be added or omitted.

The invention claimed is:

1. An extruder comprising:
a. an operational section comprising a plunger, a plunger movement control means, and a body for housing the plunger and the plunger movement control means;
b. an electrical supply means for providing an electrical supply to the means for controlling movement of the plunger; and
c. a cassette having a proximal end, a distal end, a shaping means for shaping an extrusion material attached at the distal end of the cassette, an attachment means for attaching the cassette to the body of the operational section at the proximal end of the cassette, and a cavity within which the extrusion material may be placed and through which the plunger may pass to press the material for extrusion.

2. The extruder of claim 1 wherein the plunger comprises a plunger rod having a hollow threaded interior, a distal end, and a proximal end and a head formed to fit within and press the extrusion material through the cassette and being connected to the distal end of the plunger rod; and wherein the plunger movement control means comprises a threaded post for fitting within and engaging with the hollow threaded interior of the plunger rod, a mechanical means for attaching to and placing a rotational force on the proximal end of the plunger rod such that the hollow threaded interior rotates around the threaded post and allows the plunger to extend or retract from the mechanical means, an electrical means for supplying the mechanical means with electricity, and a controller for operating the electrical means.
The extruder of claim 1 wherein the plunger comprises an innermost telescoping tube nested within at least one outer telescoping tube with each having a distal and proximal end, a head thrilled to fit within and press the extrusion material through the cassette and being connected to the distal end of an innermost telescoping tube, and a drive means for extending the innermost telescoping tube.

4. The extruder of claim 3 wherein the innermost telescoping tube comprises a threaded interior and the drive means comprises a leadscrew coupled with a nut which engages with the threaded interior of and controls the movement of the innermost telescoping tube.

5. The extruder of claim 1 further comprises a controller coupled with the plunger movement control means and electrical supply means such that electrical supply may be started or stopped.

6. The extruder of claim 5 wherein the controller further comprises a means for controlling the speed with which the plunger movement control means operates.

7. The extruder of claim 1 wherein the shaping means comprises a first die comprising an aperture which is formed to receive and shape the extrusion material and a cassette attachment means to attach to the distal end of the cassette.

8. The extruder of claim 7 wherein the shaping means further comprises a second die having a diameter smaller than the first aperture and a die attachment means to attach to the second die within the aperture of the first die.

9. The extruder of claim 8 wherein the die attachment means comprises a bridge sized to span the aperture and comprising a first end couplable with the first die on a first side of the aperture, a second end couplable with the first die on a second side opposite the aperture from the first side, and a middle connection countable with the second die such that the extrusion material will pass through a void between the first die and the second die.

10. The extruder of claim 9 wherein the bridge comprises a first zigzag section between the first end and the middle connection and a second zigzag section between the middle connection and the second end.

11. The extruder of claim wherein the operational section further comprises an indicator for displaying the location of the plunger.

12. The extruder of claim 11 wherein the indicator comprises a first light and an illumination means for illuminating the first light when the plunger is positioned such that at least one of the following conditions is met: the plunger is fully extended, the plunger is fully retracted, and the plunger is neither fully extended nor fully extracted.

13. The extruder of claim 11 wherein the indicator comprises a first light, a second light, and an illumination means for illuminating the first light when the plunger is fully extended and the second light when the plunger is fully retracted.

14. The extruder of claim 11 wherein the indicator comprises a plurality of lights and an illumination means for illumination the plurality of lights to indicate when the plunger is positioned such that at least one of the following conditions is met: the plunger is fully extended, the plunger is fully retracted, and the plunger is neither fully extended nor fully extracted.

15. The extruder of claim 1 wherein the electrical supply means comprises an AC plug located outside the body of the operational section and configured to connect to a standard electrical socket and receive the electrical supply therefrom, an AC line located outside the body of the operational section and coupled with and allowing the electrical supply to pass between the AC plug and an AC adapter also located outside the body of the operational section, a first DC line coupled with and allowing the electrical supply to pass between the AC adapter and a DC power supply located within the body of the operational section, and a second DC line coupled with and allowing the electrical supply to pass between the DC power supply and the means for controlling movement of the plunger.

16. An extruder comprising:
a. an operational section comprising
i. a plunger comprises a plunger rod having a hollow threaded interior, a distal end, and a proximal end and a head formed to fit within and press the extrusion material through the cassette and being connected to the distal end of the plunger rod,
ii. a plunger movement control means comprising a threaded post for fitting within and engaging with the hollow threaded interior of the plunger rod, a mechanical means for attaching to and placing a rotational force on the proximal end of the plunger rod such that the hollow threaded interior rotates around the threaded post and allows the plunger to extend or retract from the mechanical means, an electrical means for supplying the mechanical means with electricity, and a controller for operating the electrical means, and
iii. a body for housing the plunger and the plunger movement control means;
b. an electrical supply means for supplying electricity to the means for controlling movement of the plunger; and
c. a cassette having a proximal end, a distal end, a shaping means for shaping an extrusion material attached at the distal end of the cassette, an attachment means for attaching the cassette to the body of the operational section at the proximal end of the cassette, and a cavity within which the extrusion material may be placed and through which the plunger may pass to press the material for extrusion.

17. An extruder comprising:
a. at operational section comprising
i. a plunger comprises a plunger rod having a hollow threaded interior, a distal end, and a proximal end and a head formed to fit within and press the extrusion material through the cassette and being connected to the distal end of the plunger rod,
ii. a plunger movement control means comprising a threaded post for fitting within and engaging with the hollow threaded interior of the plunger rod, a mechanical means for attaching to and placing a rotational force on the proximal end of the plunger rod such that the hollow threaded interior rotates around the threaded post and allows the plunger to extend or retract from the mechanical means, an electrical means for supplying the mechanical means with electricity, and a controller for operating the electrical means, and
iii. a body for housing the plunger and the plunger movement control means;
b. an electrical supply means for supplying electricity to the means for controlling movement of the plunger; and
c. a cassette having a proximal end, a distal end, a first die attached at the distal end of the cassette comprising a first aperture which is formed to receive and shape the extrusion material and a cassette attachment means to attach to the distal end of the cassette, an attachment means for attaching the cassette to the body of the operational section at the proximal end of the cassette, and a cavity within which the extrusion material may be placed and through which the plunger may pass to press the material for extension.
